(19) United States
(12) Patent Application Publication
(10) Pub. No.: US 2013/0117532 A1
(43) Pub. Date: May 9, 2013

(54) INTERLEAVING ADDRESS MODIFICATION

(71) Applicants: Alexander Rabinovitch, Kfar Yona (IL); Leonid Dubrovin, Karney Shomron (IL)

(72) Inventors: Alexander Rabinovitch, Kfar Yona (IL); Leonid Dubrovin, Karney Shomron (IL)

(21) Appl. No.: 13/290,364

(22) Filed: Nov. 7, 2011

(51) Int. Cl. G06F 12/08

(52) U.S. Cl. 711/213; 711/E12.016

(57) ABSTRACT

An apparatus having a plurality of memory blocks and a circuit is disclosed. The circuit may be configured to (i) generate a second address by removing one or more first bits of a first address from one or more first locations defined by a first value, (ii) generate a third address by adding an offset value to the second address and (iii) generate a fourth address by inserting a selected one of a plurality of modifiers into the third address. The selected modifier may be inserted into the third address at the first locations. Each modifier is generally associated with a respective one of a plurality of buffers formed in the memory blocks. The circuit may also be configured to access the respective buffer of the fourth address.

### FIELD OF THE INVENTION

The present invention relates to memory addressing modes within a processor generally and, more particularly, to a method and/or apparatus for implementing an interleaving address modification.

### BACKGROUND OF THE INVENTION

A conventional digital signal processor (i.e., DSP) usually has a tightly coupled, single-clock accessible memory connected to a core of the processor. Using various memory access modes is a common practice in modern DSP processing cores. Conventional memory access modes include a modulo addressing mode and a bit reversal addressing mode. The memory is often built with a number of static random access memory (i.e., SRAM) modules of a given width and depth.

Each SRAM module can accommodate a single memory access in any given clock cycle. Modern DSP cores can produce several read accesses and write accesses in a single cycle, so multiple SRAM modules allow parallel treatment of the multiple accesses. When two busses are trying to access the same SRAM module, a conflict arises and a memory hold is generated.

A careful buffer allocation and a large number of SRAM modules are usually used for reducing the number of memory holds for common applications executing in the processor. The buffer allocations and large numbers of SRAM modules are ineffective for “butterfly” structured processes, such as a fast Fourier transform (i.e., FFT) process, a discrete Fourier transform (i.e., DFT) process and a Viterbi process.

Referring to FIG. 1, a diagram of a conventional butterfly structured process is shown. The butterfly structured process usually accesses sequential memory locations with strides of size 2^{N}, when N can be a large number. For example, if a FFT of 4096 points is implemented in Radix2, an address distance between two complex inputs (i.e., 16 bit real and 16 bit imaginary parts) to the butterfly can reach (4096/2)×4=8192 bytes. Such address gaps between complex inputs creates an issue by preventing two read accesses from being used in the same cycle, which will generate a memory hold. The issue can be solved if a process with single read and single write memory accesses per cycle is used. The solution uses the fact that in butterflies, the read and write accesses have different structures allowing for a contention probability to be reduced. In the butterfly example, the probability of contentions is ⅛ (i.e., a 12.5% performance degradation). The butterfly processes can have iterative structures (i.e., a FFT of 4096 points implemented in Radix2 has 12 iterations). Therefore, a buffer used for writes in iteration K will be read in iteration K+1. Thus, dual buffer allocations are commonly implemented.

It would be desirable to implement a method and/or apparatus for implementing an interleaving address modification.

### SUMMARY OF THE INVENTION

The present invention concerns an apparatus having a plurality of memory blocks and a circuit. The circuit may be configured to (i) generate a second address by removing one or more first bits of a first address from one or more first locations defined by a first value, (ii) generate a third address by adding an offset value to the second address and (iii) generate a fourth address by inserting a selected one of a plurality of modifiers into the third address. The selected modifier maybe inserted into the third address at the first locations. Each modifier is generally associated with a respective one of a plurality of buffers formed in the memory blocks. The circuit may also be configured to access the respective buffer of the fourth address.

The objects, features and advantages of the present invention include providing a method and/or apparatus for implementing an interleaving address modification that may (i) interleave addresses for two or more buffers established in a memory, (ii) provide an interleaved addressing mode to the buffers, (iii) establish the buffers in a non-sequential manner, (iv) utilize a memory with multiple modules operated in parallel and/or (v) be implemented in a digital signal processor.

### BRIEF DESCRIPTION OF THE DRAWINGS

These and other objects, features and advantages of the present invention will be apparent from the following detailed description and the appended claims and drawings in which:

FIG. 1 is a diagram of a conventional butterfly structured process;

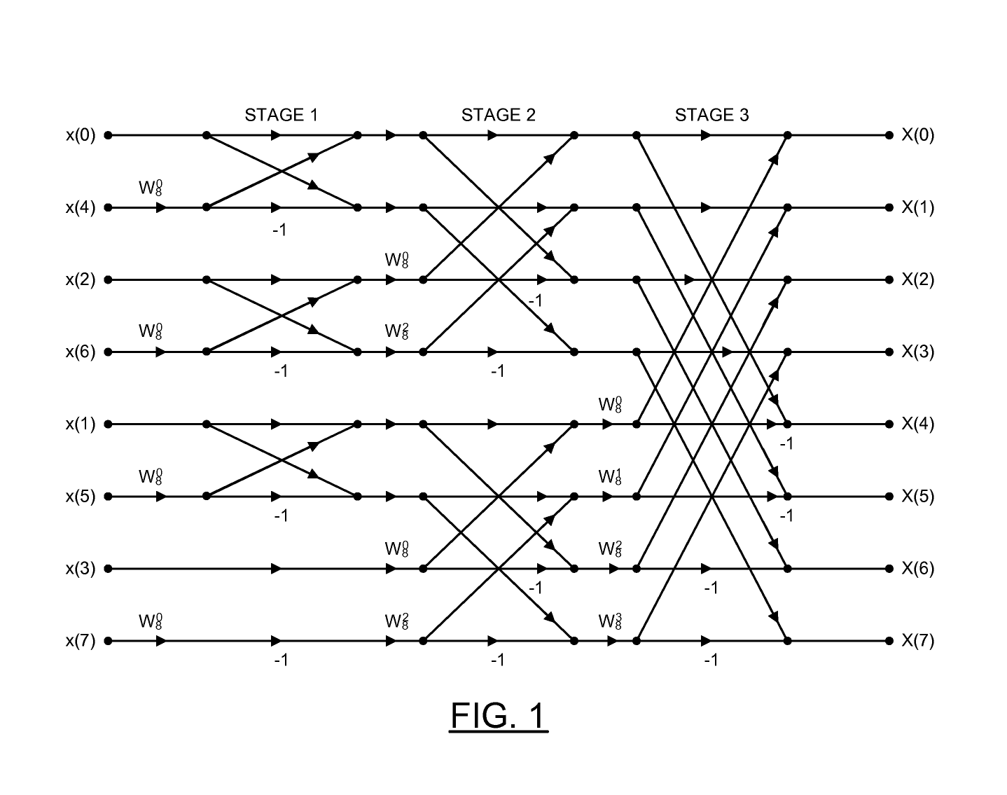

FIG. 2 is a block diagram of an example implementation of an apparatus;

FIG. 3 is a block diagram of an example implementation of a memory in accordance with a preferred embodiment of the present invention;

FIG. 4 is a flow diagram of an example method for implementing an interleaving memory access mode;

FIG. 5 is a diagram of an example interleaved memory access; and

FIG. 6 is a diagram of another example interleaved memory access.

### DETAILED DESCRIPTION OF THE PREFERRED EMBODIMENTS

Some embodiments of the present invention provide an interleaving memory access (e.g., IMA) mode that creates interleaved accesses to multiple addressable memory locations within a memory. The IMA mode generally allows optimal implementation and execution of butterfly structured processes, such as a fast Fourier transform (e.g., FFT) process, a discrete Fourier transform (e.g., DFT) process and a Viterbi process. The IMA mode generally guarantees that no contention may happen when accessing read buffers and write buffers simultaneously (e.g., within a temporally overlapping period).

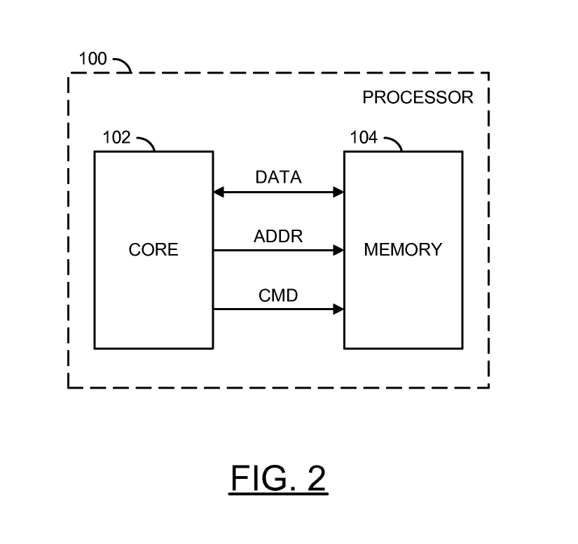

Referring to FIG. 2, a block diagram of an example implementation of an apparatus 100 is shown. The apparatus (or circuit or device or integrated circuit) 100 may implement a digital signal processor (e.g., DSP). The apparatus 100 generally comprises a block (or circuit) 102 and a block (or circuit) 104. The circuits 102-104 may represent modules and/or blocks that may be implemented as hardware, software, a combination of hardware and software, or other implementations.

A bidirectional data signal (e.g., DATA) maybe exchanged between the circuit 102 and the circuit 104. An address signal (e.g., ADDR) may be generated by the circuit 102 and presented to the circuit 104. A command signal (e.g., CMD) may also be generated by the circuit 102 and presented to the circuit 104.

The circuit 102 may implement a processor core circuit. The circuit 102 is generally operational to execute a plurality of program instructions (e.g., software programs). The programs may include, but are not limited to, butterfly structured processes, such as FFT processes, DFT processes and Viterbi processes. Data consumed by and generated within the programs may be read from and written to the circuit 104 via the signal DATA. Addressing for the data reads and writes may be provided by addresses carried in the signal ADDR. Commands to control data flow direction, addressing modes and the like, may be generated and presented in the signal CMD.

The circuit 104 may implement a memory circuit. The circuit 104 is generally operational to store the data used by and generated by the circuit 102. The circuit 104 may include multiple memory blocks. Each memory block may be individually accessed by the circuit 102 in any order, including simultaneous parallel accesses. In some embodiments, the circuit 104 may implement a static random access memory (e.g., SRAM) circuit. Other memory technologies may be implemented to meet the criteria of a particular application.

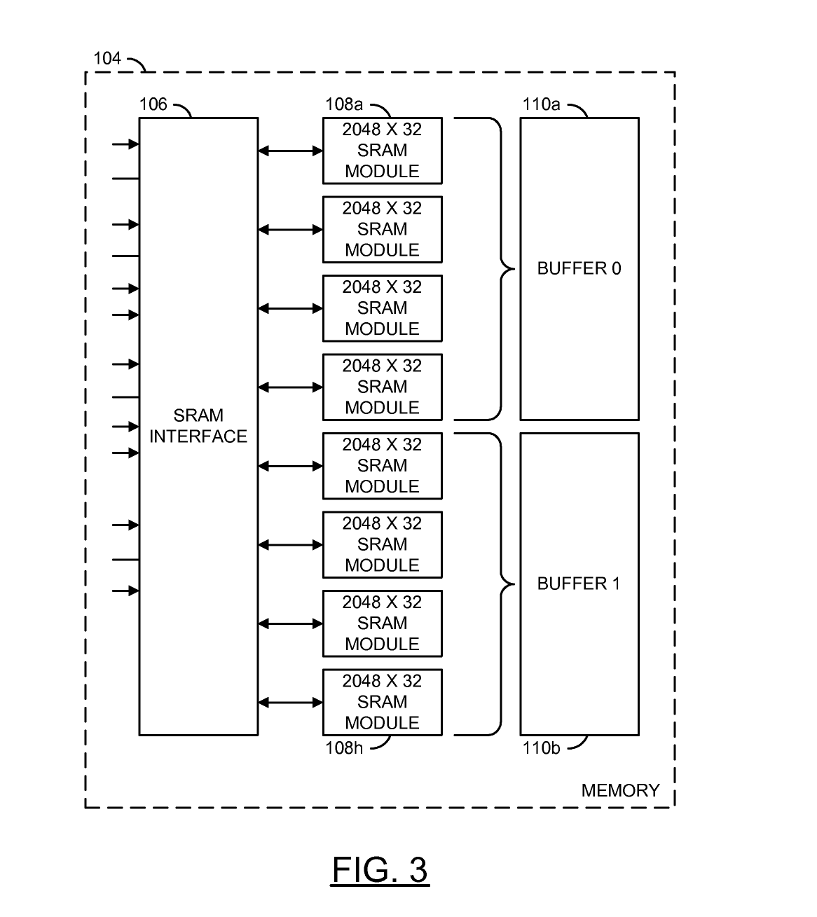

Referring to FIG. 3, a block diagram of an example implementation of the circuit 104 is shown in accordance with a preferred embodiment of the present invention. The circuit 104 generally comprises a block (or circuit) 106 and multiple blocks (or circuits) 108a-108h. The circuits 106-108h may represent modules and/or blocks that may be implemented as hardware, software, a combination of hardware and software, or other implementations.

The circuit 106 may implement a memory interface circuit. The circuit 106 is generally operational to provide the IMA mode for accessing the circuits 108a-108h. The circuit 106 may receive one or more addresses from the circuit 102 via the signal ADDR. The addresses may be altered by removing one or more bits from one or more particular locations defined by a generic mode register (e.g., GMR) value. For each address, an offset value may be added to the modified address. A selected modifier of multiple modifier values may be inserted into the altered-and-offset address. Each modifier may be associated with a respective one of two or more buffers formed in the circuits 108a-108h. The selected modifier value is generally inserted in the locations of the one or more bits defined by the GMR value. The circuit 106 may access (e.g., read, write and read-modify-write) to the selected circuit 108a-108h corresponding to the address having the modifier value.

Each circuit 108a-108h may implement a memory block. Each circuit 108a-108h may be operational to store data values written by and read to the circuit 106. In some embodiments, each circuit 108a-108h may implement an SRAM memory block of a given address size and data width. For example, each circuit 108a-108h may be illustrated in FIG. 3 as 2048 addressable locations where each location contains a 32-bit wide word. Other address ranges and/or bit-widths may be implemented to meet the criteria of a particular application.

The circuits 108a-108h may be arranged by the circuit 106 to operate as multiple buffers 110a-110b. For example, the circuits 108a-108h may be arranged in a dual buffer structure, as illustrated. The buffers 110a-110b may provide the read buffer and the write buffer used in the butterfly structured processes. Other numbers of buffers 110a-110b may be established to meet the criteria of a particular application.

For the dual buffer structure, the buffers 110a-110b may not be arranged sequentially within the address range of the circuit 104, as is usually done. Instead, the buffers 110a-110b may be interleaved in such a way that data belonging to a specific buffer is stored in the circuits 108a-108h allocated for that buffer only.

The allocation of the circuits 108a-108h to the buffers 110a-110b may be achieved in many possible ways. For operation of the interleaving memory access mode, the GMR value may be stored in a GMR register. The GMR value generally defines one or more address bit locations (e.g., GMR locations) that may be constant for specific memory accesses. The GMR value may also attach the buffers 110a-110b to specific circuits 108a-108h. Address bits in the GMR locations generally do not change for pre-increment operations of a pointer register (e.g., R#, where # is an integer 0, 1, 2, etc.) nor for post-increment operations of the register R#. Modifier registers (e.g., MR#, where # is an integer 0, 1, 2, etc.) may define the values of the constant bits in the GMR locations for the corresponding registers R#.

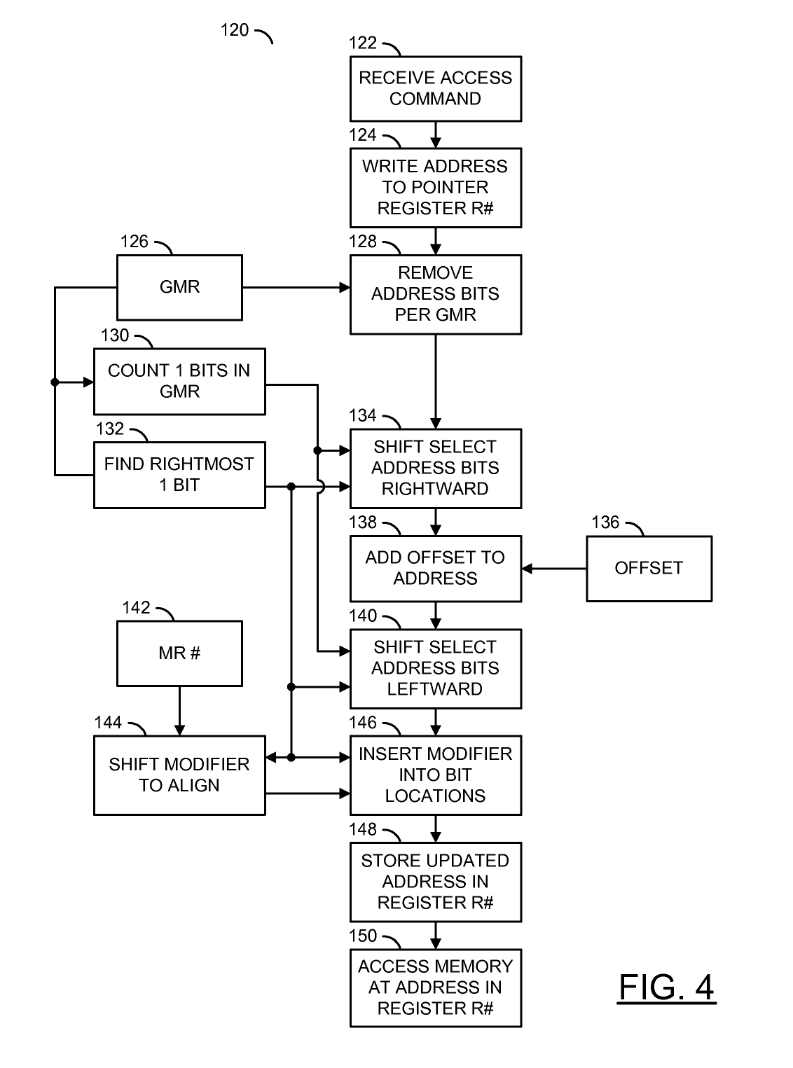

Referring to FIG. 4, a flow diagram of an example method 120 for implementing the IMA mode is shown. The method (or process) 120 may be implemented in the circuit 106. The method 120 generally comprises a step (or state) 122, a step (or state) 124, a step (or state) 126, a step (or state) 128, a step (or state) 130, a step (or state) 132, a step (or state) 134, a step (or state) 136, a step (or state) 138, a step (or state) 140, a step (or state) 142, a step (or state) 144, a step (or state) 146, a step (or state) 148 and a step (or state) 150. The steps 122-150 may represent modules and/or blocks that may be implemented as hardware, software, a combination of hardware and software, or other implementations.

In the step 122, the circuit 106 may receive an access command and an associated address from the circuit 102. The address may be written to a pointer register R# in the step 124. In the step 126, the GMR value may be retrieved from the GMR register. The address bits located at the GMR locations defined by the GMR value may be removed (e.g., set to a logical 0, a logical 1 or a don't care X) from the address value in the step 128.

The circuit 106 may count the number of logical 1 bits in the GMR value in the step 130. Each logical 1 bit in the GMR value may mark (or identify) a GMR location from which address bits may be removed in the step 128. In some embodiments, the GMR locations may be marked by logical 0 values. In the step 132, the circuit 106 may find a rightmost location (e.g., least significant location between the most significant location and the least significant location, inclusive) of a logical 1 bit in the GMR value.

In the step 134, the circuit 106 may shift some address bits to the right (e.g., toward the least significant bit) and leave other address bits in place. The shifted address bits may be the bits in locations to the left (e.g., more significant locations) than the GMR locations. A bit-distance of the shifting is generally defined by the number of consecutive logical 1 bits in the GMR value. Most significant bit locations may be padded with logical 0 or don't care X values. All address bits in locations of lesser significance than the rightmost logical 1 bit in the GMR value may remain unshifted.

In the step 136, the circuit 106 may retrieve an offset value from an offset register. The offset value may be defined in pre-increment operations and post-increment operations (or instructions) being executed by the circuit 102. The offset value may be added to the current intermediate address value in the step 138.

In the step 140, the circuit 106 may shift some address bits leftward (e.g., toward the most significant bit) and not shift other address bits. In particular, all locations more significant than and the location matching the logical 1 bits in the GMR value may be shifted. A bit-distance of the shift may match the consecutive number of logical 1 values in the GMR value. The shift left in the step 140 generally reverses the earlier shift right in the step 134.

In the step 142, the circuit 106 may retrieve a modifier value from the register MR# corresponding to the buffer 110a-110b about to be accessed. In the step 144, the modifier value may be shifted to the left. The shift may align a least significant bit of the modifier value to the rightmost logical 1 bit in the GMR value (e.g., the rightmost GMR location). In the step 146, the aligned modifier value (bits) may be inserted into the address value at the GMR locations. The updated address value may be stored in the register R# in the step 148. In the step 150, the circuit 106 may use the updated address value to access a corresponding circuit 108a-108h.

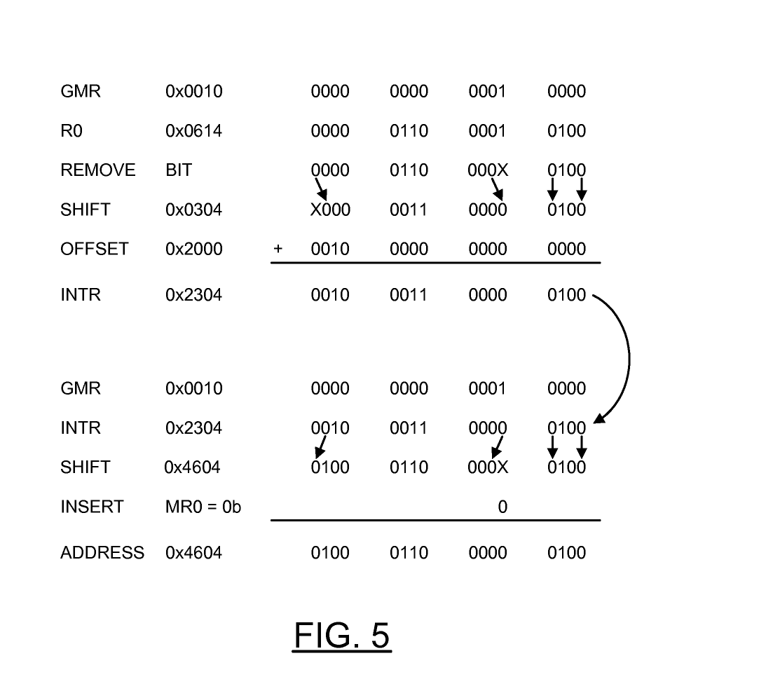

Referring to FIG. 5, a diagram of an example interleaved memory access is shown. The example generally transforms an initial address (e.g., 0×0614) into a final (or physical) address (e.g., 0×4064) of the circuits 108a-108h as part of a pre/post-increment operation. The example may access a Buffer0 (e.g., buffer 110a). Accesses to the Buffer0 may be made through a register RO. Access to a Buffer1 (e.g., buffer 110b) may be made through a register R1. The GMR value used in the example may be 0×0010 hexidecimal (e.g., 0000 0000 0001 0000 binary). A modifier value (e.g., 0 binary) for Buffer0 may be stored in a register MR0. A modifier value (e.g., 1 binary) for the Buffer1 may be stored in a register MR1.

Post-increment modifications and/or pre-increment modifications for values in the R# registers may consider the GMR value and the modifier values. As such, the address bits in the GMR locations as defined by the GMR value are generally not affected (or altered) by the pre/post-increment operations defined in the program instructions.

The example may illustrate a pre-increment modification caused by a move program instruction (e.g., move.l (R0+#0×2000), D0). The program instruction move.l (R0+#0×2000), D0 generally increments an address stored in the register R0 by an offset value 0×2000. After incrementing the address, the program instructions moves (stores) the contents of a data register (e.g., register D0) to the circuit 104 at the incremented address now stored in the register R0.

The address in the register R0 may be transformed by removing the (logical 1) bit in the GMR location (e.g., the fifth location from the right). The bits in the more significant locations (e.g., to the left of the logical 1 bit in GMR) may be shifted by a bit rightward to fill the GMR bit location (e.g., X). The bits in less significant locations than the GMR location may remain unshifted. The address value may be 0×0614 before the removal of the bit and 0×0304 after the removal and shift.

A pre (or post) calculation may be executed to add the offset value to the address value (e.g., 0×0304+0×2000=0×2304) to generate an intermediate (e.g., INTR) address value. The intermediate address value may be shifted again once the offset value has been added. The next shift may reverse the earlier shift by moving the bits in the GMR location and the more significant locations. The shift may be a single bit leftward. The bits in less significant locations than the GMR location may remain unshifted.

The shifting leftward may leave the GMR location (e.g., X) with an undefined value. Therefore, the bit defined in the register MR0 (e.g., 0 binary) may be inserted into the GMR location. The address value may be modified from the intermediate value of 0×2304 to a final value of 0×4604. The final address value may be stored to the register R0 and/or used to access the appropriate circuit 108a-108h.

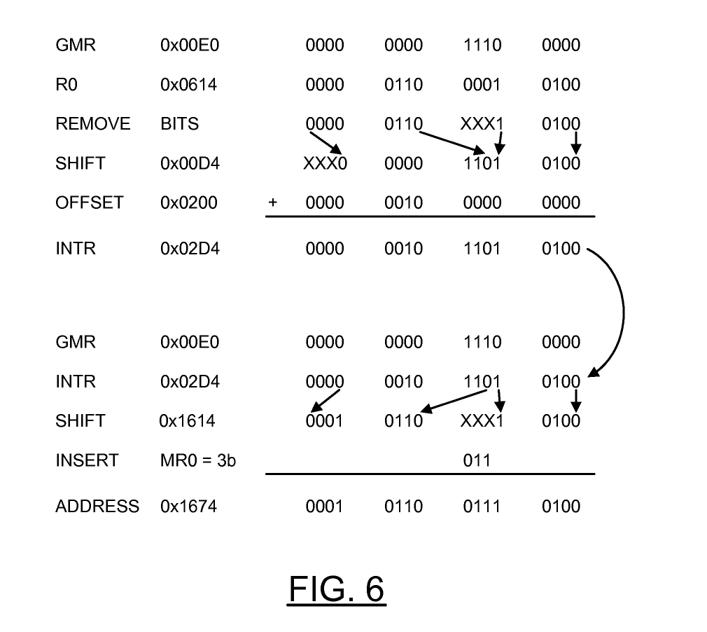

Referring to FIG. 6, a diagram of another example interleaved memory access is shown. The example generally transforms an initial address (e.g., 0×0614) into a final (or physical) address (e.g., 0×1674) of the circuits 108a-108h as part of a pre/post-increment operation. The GMR value used in the example may be 0×00E0 hexidecimal (e.g., 0000 0000 1110 000 binary). A modifier value of 3 (e.g., 011 binary) for Buffer° may be stored in a register MR0.

The example may illustrate a pre-increment modification caused by a move program instruction (e.g., move.l (R0+#0×0200), D0). The program instruction move.l (R0+#0×0200), D0 generally increments an address stored in the register R0 by an offset value 0×0200. After incrementing the address, the program instructions moves (stores) the contents of a data register (e.g., register D0) to the circuit 104 at the incremented address now stored in the register R0.

The address in the register R0 may be transformed by removing the three (logical 0) bits in the GMR locations (e.g., the sixth through eighth locations from the right). The bits in the more significant locations (e.g., the 8 most significant bits may be shifted by 3 bits rightward to fill the GMR bit locations (e.g., XXX). The bits in less significant locations than the GMR location may remain unshifted. The address value may be 0×0614 before the removal of the bits and 0×00D4 after the removal and shift.

The pre (or post) calculation may be executed to add the offset value to the resulting address value (e.g., 0×00D4+0×0200=0×02D4) to generate an intermediate (e.g., INTR) address value. The intermediate address value may be shifted again once the offset value has been added. The next shift may reverse the earlier shift by moving the bits in the GMR locations and the more significant locations. The shift may be three bits leftward. The bits in less significant locations than the GMR location may remain unshifted.

The shifting leftward may leave the GMR locations (e.g., XXX) with undefined bits. Therefore, the bits defined in the register MR0 (e.g., 011 binary) may be inserted into the GMR locations. The address value may be modified from the intermediate value of 0×002D4 to a final value of 0×1674. The final address value may be stored to the register R0 and/or used to access the appropriate circuit 108a-108h.

The interleaving memory access mode methodology generally allows an allocation of several buffers 110a-110b into different circuits 108a-108h. The buffers 110a-110b may be allocated to any one or more of the different circuits 108a-108h, in partially overlapped circuits 108a-108h and/or in the same circuits 108a-108h. More than two buffers 110a-110b may be allocated, depending on the criteria of a particular application. Allocation of additional buffers generally results in an increase in the number of GMR locations and a number of bits in the modifiers. For example, an allocation of 4 buffers may result in a corresponding GMR value having 2 consecutive logical 1 bits and 4 modifiers (e.g., a modifier for each buffer) each having widths of 2 bits. An allocation of 8 buffers may result in a corresponding GMR value having 3 consecutive logical 1 bits and 8 modifiers each having widths of 3 bits.

The functions performed by the diagrams of FIGS. 2-4 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application. As used herein, the term “simultaneously” is meant to describe events that share some common time period but the term is not meant to be limited to events that begin at the same point in time, end at the same point in time, or have the same duration.

While the invention has been particularly shown and described with reference to the preferred embodiments thereof, it will be understood by those skilled in the art that various changes in form and details may be made without departing from the scope of the invention.

1. An apparatus comprising:
a plurality of memory blocks; and
a circuit configured to (i) generate a second address by removing one or more first bits of a first address from one or more first locations defined by a first value, (ii) generate a third address by adding an offset value to said second address, (iii) generate a fourth address by inserting a selected one of a plurality of modifiers into said third address, wherein (a) said selected modifier is inserted into said third address at said first locations and (b) each of said modifiers is associated with a respective one of a plurality of buffers formed in said memory blocks, and (iv) access said respective buffer of said fourth address.

2. The apparatus according to claim 1, wherein said modifiers interleave a plurality of accesses to said buffers such that no contentions occur when reading from one of said buffers temporally overlaps with writing to another of said buffers.

3. The apparatus according to claim 1, wherein said circuit is further configured to shift each of said first bits within said first address in one or more second locations to fill said first locations before said offset value is added, wherein said second locations are more significant locations than said first locations.

4. The apparatus according to claim 1, wherein said circuit is further configured to shift each of a plurality of second bits within said third address in both (i) said first locations and (ii) one or more second locations to clear said first locations before inserting said selected modifier, wherein said second locations are more significant locations than said first locations.

5. The apparatus according to claim 1, wherein said circuit is further configured to find a number of consecutive locations within said first value having a particular bit value, wherein said first locations match said consecutive locations.

6. The apparatus according to claim 1, wherein said circuit is further configured to find a least significant location in within said first value having a particular bit value.

7. The apparatus according to claim 6, wherein said circuit is further configured to shift said selected modifier to align with said least significant location before insertion into said third address.

8. The apparatus according to claim 1, wherein said first locations contain one or more second bits in said fourth address that are constant across each respective address range of said buffers.

9. The apparatus according to claim 1, wherein said apparatus forms part of a digital signal processor.

10. The apparatus according to claim 1, wherein said apparatus is implemented as one or more integrated circuits.

11. A method for interleaving address modification, comprising the steps of:
(A) generating a second address by removing one or more first bits of a first address from one or more first locations defined by a first value;
(B) generating a third address by adding an offset value to said second address;
(C) generating a fourth address by inserting a selected one of a plurality of modifiers into said third address, wherein (i) said selected modifier is inserted into said third address at said first locations and (ii) each of said modifiers is associated with a respective one of a plurality of buffers formed in a plurality of memory blocks; and
(D) accessing said respective buffer of said fourth address.

12. The method according to claim 11, wherein said modifiers interleave a plurality of accesses to said buffers such that no contentions occur when reading from one of said buffers temporally overlaps with writing to another of said buffers.

13. The method according to claim 11, further comprising the step of:
shifting each of said first bits within said first address in one or more second locations to fill said first locations before said offset value is added, wherein said second locations are more significant locations than said first locations.

14. The method according to claim 11, further comprising the step of:
shifting each of a plurality of second bits within said third address in both (i) said first locations and (ii) one or more second locations to clear said first locations before inserting said selected modifier, wherein said second locations are more significant locations than said first locations.

15. The method according to claim 11, further comprising the step of:
finding a number of consecutive locations within said first value having a particular bit value, wherein said first locations match said consecutive locations.

16. The method according to claim 11, further comprising the step of:
finding a least significant location in within said first value having a particular bit value.

17. The method according to claim 16, further comprising the step of:
shifting said selected modifier to align with said least significant location before insertion into said third address.

18. The method according to claim 11, wherein said first locations contain one or more second bits in said fourth address that are constant across each respective address range of said buffers.

19. The method according to claim 11, wherein said method is implemented in a digital signal processor.

20. An apparatus comprising:
means for generating a second address by removing one or more first bits of a first address from one or more first locations defined by a first value;
means for generating a third address by adding an offset value to said second address;
means for generating a fourth address by inserting a selected one of a plurality of modifiers into said third address, wherein (i) said selected modifier is inserted into said third address at said first locations and (ii) each of said modifiers is associated with a respective one of a plurality of buffers formed in a plurality of memory blocks; and
means for accessing said respective buffer of said fourth address.
